(19) United States
(12) Patent Application Publication
(10) Pub. No.: US 2007/0249449 A1
(43) Pub. Date: Oct. 25, 2007

(54) Chain plate with wings

(75) Inventor: Daniel Wu, Tainan City (TW)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KMC CHAIN INDUSTRIAL CO., LTD.

(21) Appl. No.: 11/790,034

(22) Filed: Apr. 23, 2007

(30) Foreign Application Priority Data
Apr. 25, 2006 (TW) 095114730

(51) Int. Cl. F16G 13/02

(52) U.S. Cl. 474/206

(57) ABSTRACT

A chain plate includes a plate body and a first wing. The plate body has a first side surface adapted to face an abutment plate, a second side surface opposite to the first side surface, and an annular peripheral surface interconnecting outer peripheries of the first and second side surfaces and having first and second ends opposite to each other in a longitudinal direction. The first wing extends integrally from the first end of the peripheral surface in the longitudinal direction, and has a first side surface facing the abutment plate. The distance between the first side surface of the first wing and the abutment plate is smaller than that between the first side surface of the plate body and the abutment plate.

### CROSS-REFERENCE TO RELATED APPLICATION

This application claims priority of Taiwanese Application No. 095114730, filed on Apr. 25, 2006.

### BACKGROUND OF THE INVENTION

1. Field of the Invention

This invention relates to a chain, and more particularly to a chain plate that is one element of a chain and that is formed with wings.

2. Description of the Related Art

Referring to FIG. 1, a conventional chain typically includes a plurality of chain link units 7 and a connecting unit 8. Each of the chain link units 7 includes two inner chain plates 71, a lining sleeve 70 interconnecting the inner chain plates 71, two outer chain plates 72 located respectively to two sides of an assembly of the inner chain plates 71, a chain roller 73 disposed between the inner chain plates 71, and a chain pin 74 extending through the lining sleeve 70 and connected to the outer chain plates 72. The connecting unit 8 includes two link pins 81 each extending through the inner chain plates 71 of an adjacent chain link unit 7, and two link plates 82 interconnecting the link pins 81. Each of the link pins 81 has a retaining end portion 811, an anchoring end portion 812 opposite to the retaining end portion 811, and a neck portion 813 connected to the retaining end portion 811. Each of the link plates 82 has a through hole 821 and a retaining hole 822 spaced apart from each other. Each of the retaining holes 822 has a large-diameter hole portion sized to permit movement of the corresponding retaining end portion 811 therethrough, and a small-diameter hole portion connected to the large-diameter hole portion and having a diameter-increased end 814 for receiving fittingly the corresponding retaining end portion 811. The neck portions 813 are disposed respectively within the small-diameter portions of the retaining holes 822.

When it is desired to connect one link pin 81 and one link plate 82 to one inner chain plate 71, the retaining end portion 811 of the link pin 81 is first passed through and projected outwardly from the large-diameter portion of the retaining hole 822 in the link plate 82. Next, the retaining end portion 811 is moved away from the through hole 821 to a position whereat the retaining end portion 811 is aligned with the small-diameter hole portion of the retaining hole 822, and subsequently into the diameter-increased end 814 of the small-diameter hole portion of the retaining hole 822. However, the inner chain plate 71 is spaced apart from the link plate 82 by an excessively long distance (d1) that results in frequent relative movement between the inner chain plate 71 and the link plate 82 and, thus, removal of the link plate 82 from the link pin 81.

Similarly, a space needs to be formed between an adjacent pair of inner and outer chain plates 71, 72 to allow relative rotation therebetween. Excessively large spaces between the inner and outer chain plates 71, 72, however, result in frequent collision and, thus, a large amount of collision noise therebetween.

### SUMMARY OF THE INVENTION

The object of this invention is to provide a chain plate that is one element of a chain and that abuts against another plate of the chain in such a manner that they are spaced apart from each other by a minimal distance, thereby reducing the collision and, hence, the collision noise occurring therebetween.

According to this invention, a chain plate includes a plate body and a first wing. The plate body has a first side surface adapted to face an abutment plate, a second side surface opposite to the first side surface, and an annular peripheral surface interconnecting outer peripheries of the first and second side surfaces and having first and second ends opposite to each other in a longitudinal direction. The first wing extends integrally from the first end of the peripheral surface in the longitudinal direction, and has a first side surface facing the abutment plate. The distance between the first side surface of the first wing and the abutment plate is smaller than that between the first side surface of the plate body and the abutment plate.

When the chain plate is pivoted relative to the abutment plate by an angle, e.g., 90 degrees, relative movement therebetween is allowed. In this state, the chain plate can be removed from the abutment plate.

As such, the first wing can be spaced apart from the abutment plate by a short distance. Thus, the collision between the chain plate and the abutment plate is reduced.

### BRIEF DESCRIPTION OF THE DRAWINGS

These and other features and advantages of this invention will become apparent in the following detailed description of the preferred embodiments of this invention, with reference to the accompanying drawings, in which:

FIG. 1 is a fragmentary sectional view of a conventional chain;

FIG. 2 is a fragmentary sectional view of a chain including the first preferred embodiment of a chain plate according to this invention, which serves as a link plate;

FIG. 3 is a perspective view of the first preferred embodiment;

FIG. 4 is a fragmentary, partly exploded sectional view of the chain shown in FIG. 2;

FIGS. 5 and 6 are schematic views illustrating how the first preferred embodiment is assembled to an abutment plate;

FIG. 7 is a fragmentary front view of the chain shown in FIG. 2, illustrating the normal position of the first preferred embodiment relative to the abutment plate; and

FIG. 8 is a fragmentary partly sectional side view of a chain including the second preferred embodiment of a chain plate according to this invention.

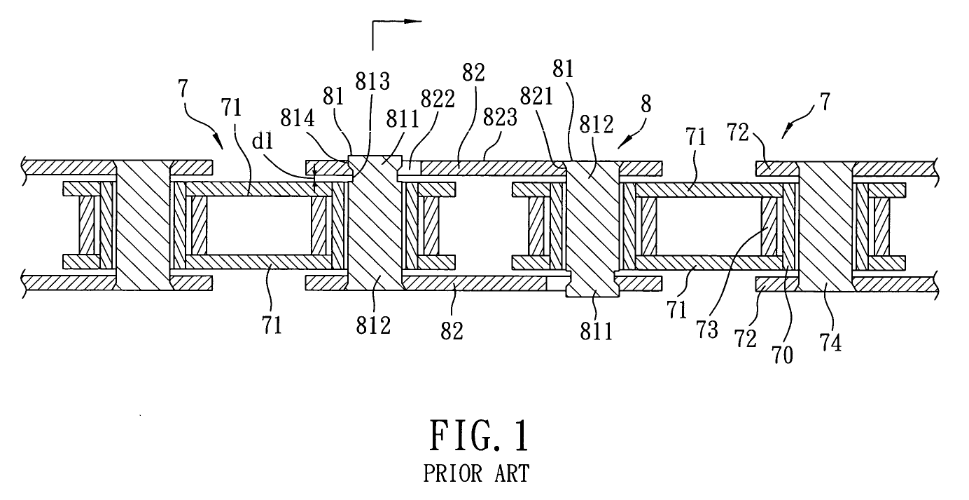

### DETAILED DESCRIPTION OF THE PREFERRED EMBODIMENTS

Before the present invention is described in greater detail in connection with the preferred embodiments, it should be noted that similar elements and structures are designated by like reference numerals throughout the entire disclosure.

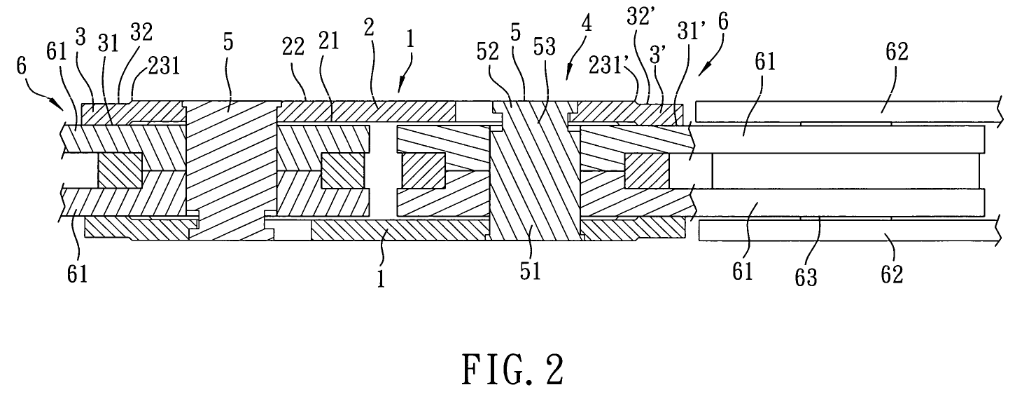

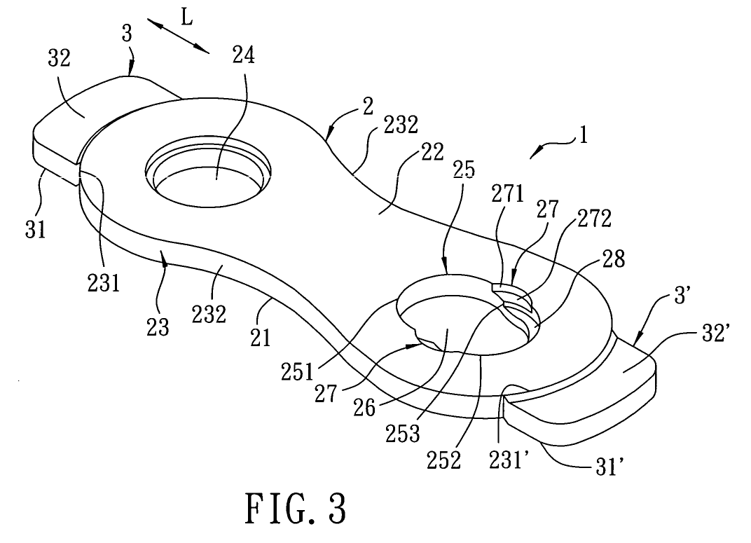

Referring to FIGS. 2 and 3, a chain typically includes a plurality of chain link units 6 and a connecting unit 4. Each of the chain link units 6 includes two inner chain plates 61, two outer chain plates 62 located respectively to two sides of an assembly of the inner chain plates 61, and a chain pin 63 extending through the inner and outer chain plates 61, 62. The connecting unit 4 includes two link pins 5 and two link plates interconnecting the link pins 5. The first preferred embodiment of a chain plate 1 according to this invention is applicable to any of the inner and outer chain plates 61, 62 and the link plates of the connecting unit 4, and is used with an abutment plate. When the chain plate 1 serves as any of the link plates of the connecting unit 4 and the outer chain plates 62, the abutment plate is the adjacent inner chain plate 61. When the chain plate 1 serves as one of the inner chain plates 61, the abutment plate is the adjacent outer chain plate 62 or the adjacent link plate. The chain plate 1 exemplified in this embodiment is one of the link plates of the connecting unit 4. Thus, the abutment plate is the adjacent inner chain plate 61. Each of the link pins 5 has an anchoring end portion 51, a retaining end portion 52 opposite to the anchoring end portion 51, and a neck portion 53 connected to the retaining end portion 52.

The chain plate 1 in this embodiment includes a gourd-shaped plate body 2 and first and second wings 3, 3′.

The plate body 2 has a first side surface 21 facing the abutment plate (i.e., the adjacent inner chain plate) 61, a second side surface 22 opposite to the first side surface 21, an annular peripheral surface 23 interconnecting outer peripheries of the first and second side surfaces 21, 22, a through hole 24 extending from the first side surface 21 to the second side surface 22, an inner surrounding surface 25 extending from the first side surface 21 to the second side surface 22 to define a retaining hole 26, two notches 27 formed between the second side surface 22 and the inner surrounding surface 25, and a flange 28 extending inwardly from the inner surrounding surface 25, adjacent to the first side surface 21, and spaced apart from the second side surface 22. The first side surface 21 of the plate body 2 is spaced apart from the abutment plate 61.

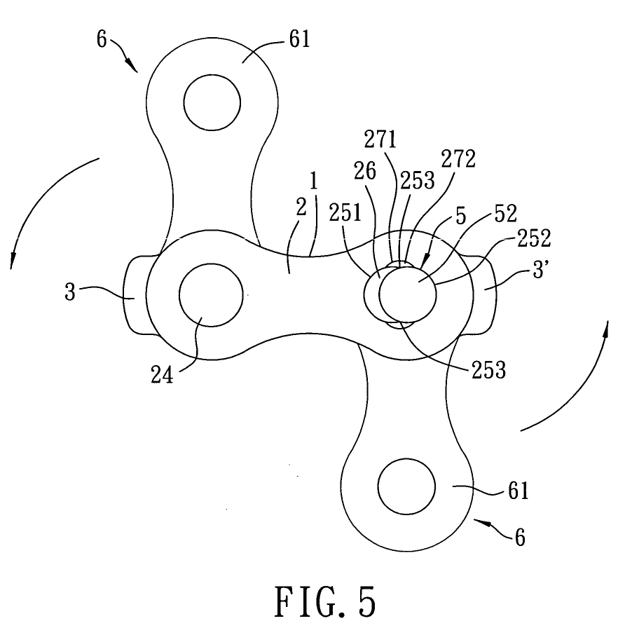

The peripheral surface 23 has first and second ends 231, 231′ opposite to each other in a longitudinal direction (L), and two middle portions 232. The inner surrounding surface 25 has a curved mounting portion 251 proximate to the through hole 24, and a curved positioning portion 252 distal from the through hole 24. The positioning portion 252 has two opposite positioning ends 253 (see FIG. 5) connected respectively to two ends of the mounting portion 251. The flange 28 is formed on the positioning portion 252. The distance between the positioning ends 253 is smaller than the diameter of the retaining end portion 52 of the link pin 5.

Each of the notches 27 is disposed between the mounting portion 251 and the positioning portion 252, and is defined by a curved bridging surface portion 271 extending downwardly from the second side surface 22, and a flat sliding surface portion 272 parallel to the first and second side surfaces 21, 22. The sliding surface portion 272 is disposed on a plane between the second side surface 22 and the flange 28. The inner surrounding surface 25, the notches 27, and the flange 28 cooperate to allow the link pin 5 to be assembled to the chain plate 1. Since the detailed structures of the inner surrounding surface 25, the notches 27, and the flange 28 are not pertinent to the claimed invention, a description thereof will be omitted herein for the sake of brevity.

The first and second wings 3, 3′ extend respectively and integrally from the first and second ends 231, 231′ of the peripheral surface 23 away from each other in the longitudinal direction (L), and has the same thickness as the plate body 2. Each of the first and second wings 3, 3′ has a first side surface 31, 31′ facing the abutment plate 61, and a second side surface 32, 32′ opposite to and parallel to the first side surface 31, 31′. The first side surfaces 31, 31′ are spaced apart from the abutment plate 61 by a minimal distance that is smaller than the distance between the first side surface 21 of the plate body 2 and the abutment plate 61. That is, the first side surfaces 31, 31′ of the first and second wings 3, 3′ are in slidable contact with the abutment surface 61. The second side surfaces 32, 32′ of the first and second wings 3, 3′ are spaced apart from and parallel to the second side surface 22 of the plate body 2, and are disposed on a plane that is located between the first and second side surfaces 21, 22 of the plate body 2. Alternatively, the second side surfaces 32, 32′ of the first and second wings 3, 3′ may be aligned with the second surface 22 of the plate body 2.

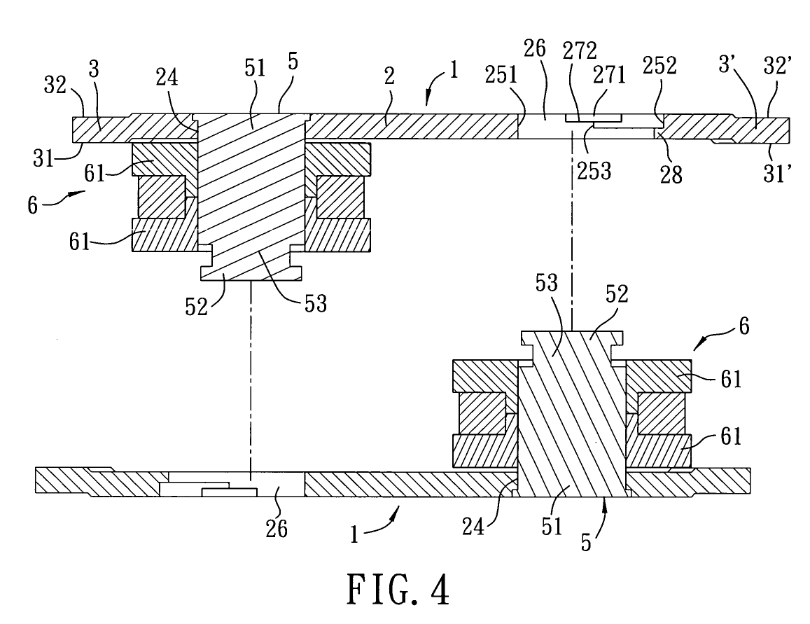

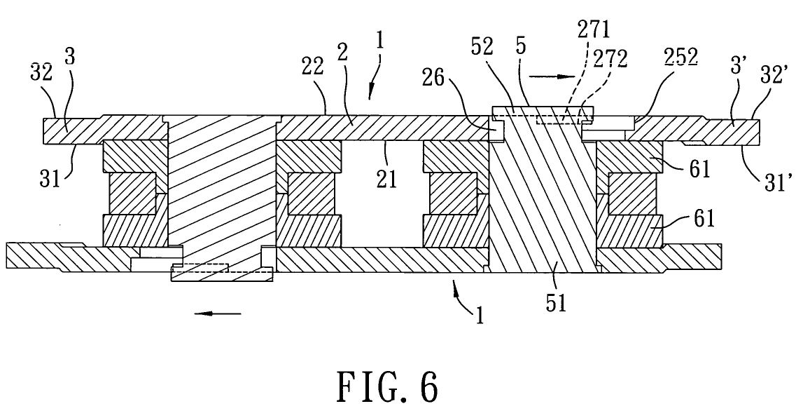

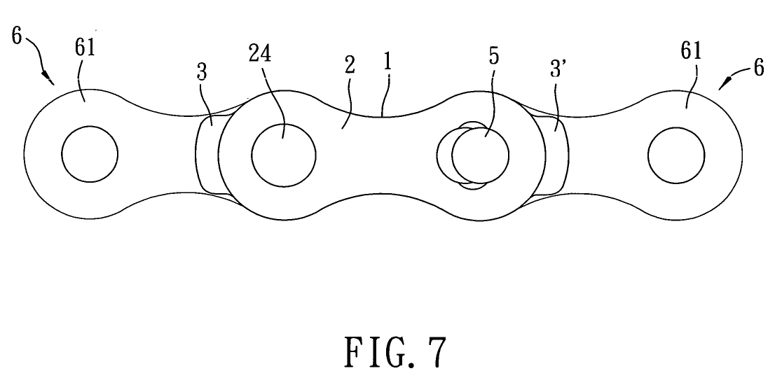

With further reference to FIG. 4, when it is desired to interconnect two chain plates 1, the anchoring end portions 51 of two link pins 5 are first riveted respectively within the through holes 24 in the chain plates 1. Next, the chain plates 1 are placed respectively on two abutment plates 61 such that each of the chain plates 1 cooperates with an adjacent abutment plate 61 to form an L-shaped structure, as shown in FIG. 5. Subsequently, the retaining end portions 52 of the link pins 5 are respectively passed through the abutment plates 61 and into the retaining holes 26 in the chain plates 1 to project outwardly from the sliding surface portions 272, as shown in FIG. 6. Further, the link pins 5 are moved respectively within the retaining holes 26, and the chain plates 1 are pivoted respectively relative to the inner chain plates 61 by an angle of about 90 degrees to normal positions so as to align therewith, as shown in FIG. 7. As a result, the first and second wings 3, 3′ come into slidable contact with the abutment plates 61, respectively, as shown in FIG. 6, thereby retaining the chain plates 1 on the abutment plates 61, respectively.

Since the first and second wings 3, 3′ are kept in slidable contact with the abutment plates 61, relative movement between the chain plates 1 and the abutment plates 61, which would result in collision therebetween, is minimized. Thus, the object of this invention is achieved. It should be noted that, when the chain plate 1 of this invention is formed with only one wing 3, 3′, the object of this invention can also be achieved.

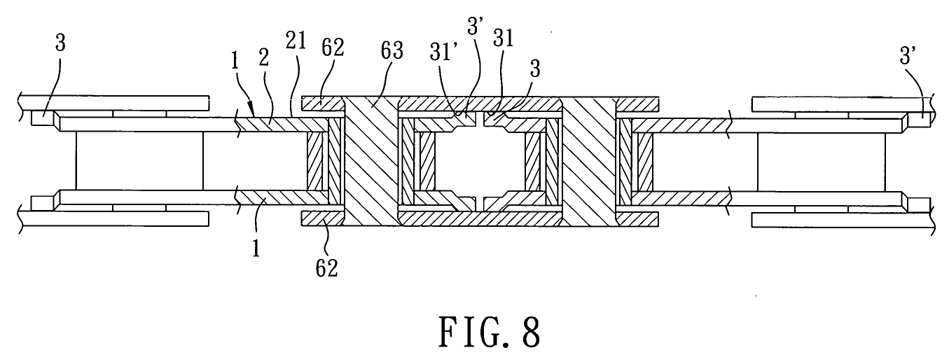

Referring to FIG. 8, the second preferred embodiment of a chain plate 1 according to this invention serves as an inner chain plate, and is used with an outer chain plate 62. The chain plate 1 is connected to the abutment plate (i.e., the outer chain plate) 62 by one chain pin 63. The chain plate 1 includes a plate body 2, and a pair of first and second wings 3, 3′. The first side surfaces 21, 31, 31′ of the plate body 2 and the first and second wings 3, 3′ face the abutment plate 62. The first side surfaces 31, 31′ of the first and second wings 3, 3′ are spaced apart from the abutment plate 62 by a minimal distance that is smaller than the distance between the first side surface 21 of the plate body 2 and the abutment plate 62.

With this invention thus explained, it is apparent that numerous modifications and variations can be made without departing from the scope and spirit of this invention. It is therefore intended that this invention be limited only as indicated by the appended claims.

I claim:

1. A chain plate adapted to abut against and be retained on an abutment plate and comprising:
a plate body having a first side surface adapted to face the abutment plate, a second side surface opposite to said first side surface, and an annular peripheral surface interconnecting outer peripheries of said first and second side surfaces and having first and second ends opposite to each other in a longitudinal direction, said first side surface of said plate body being adapted to be spaced apart from the abutment plate; and
a first wing extending integrally from said first end of said peripheral surface in said longitudinal direction and having a first side surface adapted to face the abutment plate, a distance between said first side surface of said first wing and the abutment plate being smaller than that between said first side surface of said plate body and the abutment plate.

2. The chain plate as claimed in claim 1, further comprising a second wing extending integrally from said second end of said peripheral surface of said plate body away from said first wing, said second wing having also a first side surface adapted to face the abutment plate, a distance between said first side surface of said second wing being smaller than that between said first side surface of said plate body and the abutment plate.

3. The chain plate as claimed in claim 2, wherein said plate body further has a through hole formed therethrough, and an annular inner surrounding surface defining a retaining hole formed through said plate body, said inner surrounding surface having a mounting portion, a positioning portion, and two notches formed between said mounting portion and said positioning portion, said positioning portion being formed with a flange extending inwardly therefrom, adjacent to said first side surface of said plate body, and spaced apart from said second side surface of said plate body.

4. The chain plate as claimed in claim 2, wherein each of said first and second wings further has a second side surface spaced apart from and parallel to said second side surface of said plate body and disposed on a plane that is located between said first and second side surfaces of said plate body.

5. The chain plate as claimed in claim 4, wherein said plate body further has a through hole formed therethrough, and an annular inner surrounding surface defining a retaining hole formed through said plate body, said inner surrounding surface having a mounting portion, a positioning portion, and two notches formed between said mounting portion and said positioning portion, said positioning portion being formed with a flange extending inwardly therefrom, adjacent to said first side surface of said plate body, and spaced apart from said second side surface of said plate body.

6. The chain plate as claimed in claim 1, wherein said plate body further has a through hole formed therethrough, and an annular inner surrounding surface defining a retaining hole formed through said plate body, said inner surrounding surface having a mounting portion, a positioning portion, and two notches formed between said mounting portion and said positioning portion, said positioning portion being formed with a flange extending inwardly therefrom and, adjacent to said inner first side surface of said plate body, and spaced apart from said second side surface of said plate body.
